(19) United States
(12) Patent Application Publication
(10) Pub. No.: US 2007/0085771 A1
(43) Pub. Date: Apr. 19, 2007

(54) Driving method of plasma display device

(76) Inventors: Suk-Jae Park, Yongin-si (KR); Woo-Joon Chung, Yongin-si (KR); Jin-Ho Yang, Yongin-si (KR); Seong-Joon Jeong, Yongin-si (KR); Tae-Seong Kim, Yongin-si (KR); Seung-Min Kim, Yongin-si (KR)

Correspondence Address: CHRISTIE, PARKER & HALE, LLP, PO BOX 7068, PASADENA, CA, 91109-7068, US

(21) Appl. No.: 11/544,208

(22) Filed: Oct. 5, 2006

(30) Foreign Application Priority Data
Oct. 18, 2005 (KR) 10-2005-0098025

(51) Int. Cl. G09G 3/28

(52) U.S. Cl. 345/67

(57) ABSTRACT

In a sustain period, a positive voltage is applied to an address electrode during at least one part of a period for applying a last sustain discharge pulse that is gradually increased and applied to a scan electrode. In this manner, an occurrence of misfiring between the address electrode and the sustain electrode of a discharge cell that is sustain-discharged without having been addressed in the next consecutive subfield is reduced or prevented.

### CROSS-REFERENCE TO RELATED APPLICATION

This application claims priority to and the benefit of Korean Patent Application No. 10-2005-0098025, filed on Oct. 18, 2005 in the Korean Intellectual Property Office, the entire content of which is incorporated herein by reference.

### BACKGROUND OF THE INVENTION

(a) Field of the Invention

The present invention relates to a driving method of a plasma display device including a plasma display panel (PDP).

(b) Description of the Related Art

A plasma display device is a flat panel display that uses plasma generated by a gas discharge process to display characters or images.

In a driving method of a plasma display device, one frame is divided into a plurality of subfields, and the subfields are time-divisionally controlled to thus represent grayscale levels. Each subfield includes a reset period, an address period, and a sustain period. The reset period is for initializing each cell of the plasma display device so as to facilitate an addressing operation on the cell. The address period is for selecting cells to be turned on or turned off to display an image. That is, for the address period, a scan pulse (or signal) is sequentially applied to a plurality of scan electrodes, and an address pulse (or signal) is applied to an address electrode. Here, an address discharge is generated in a cell where the scan pulse and the address pulse are applied at the same time. For the sustain period, a sustain discharge pulse (or signal) alternately (or repeatedly and alternately) having a high level voltage and a low level voltage is applied to a scan electrode and a sustain electrode. Here, a sustain pulse phase applied to the scan electrode is opposite to a sustain pulse phase applied to the sustain electrode.

Also, negative (−) wall charges are formed on an address electrode of the cell selected to be turned on in the address period, and therefore, a discharge may be generated between the scan electrode applied with the high level voltage and the address electrode. That is, an inappropriate sustain discharge may be generated when the address electrode is biased with a ground voltage. As such, to block such an inappropriate sustain discharge, a positive (+) voltage is applied to the address electrode when a sustain discharge pulse is initially applied to the scan or sustain electrode.

However, in the reset period, the state of the cells may be reset while a considerable amount of positive (+) wall charges are formed on the address electrode. Then, in the sustain period, when a low-level sustain discharge pulse is applied to the sustain electrode and the positive voltage is applied to the address electrode in such a state, misfiring (or an inappropriate discharge) may occur between a sustain electrode and an address electrode of an unselected cell.

That is, the positive (+) wall charges formed on the address electrode and the positive voltage applied to the address electrode may cause the occurrence of misfiring (or an inappropriate discharge) between the address electrode and the sustain electrode of the cell that is not selected in the address period.

### SUMMARY OF THE INVENTION

An aspect of the present invention provides a plasma display device that can reduce or prevent a discharge cell that has not been addressed from being misfired (or discharged) during a sustain period.

An exemplary driving method according to an embodiment of the present invention drives a plasma display device having a plurality of first electrodes, a plurality of second electrodes, and a plurality of third electrodes formed in a direction crossing the plurality of first electrodes and the plurality of second electrodes. In addition, a plurality of discharge cells are formed in areas defined by the first, second, and third electrodes. In the driving method, in a sustain period of at least one subfield of a plurality of subfields, a first sustain discharge pulse alternately having a first high level voltage and a first low level voltage is applied to the plurality of first electrodes, the plurality of third electrodes are biased with a positive first voltage for a first period that includes at least one part of a period for initially applying the first high level voltage to the plurality of first electrodes, a voltage of the plurality of first electrodes is gradually increased after finally applying the first high level voltage to the plurality of first electrodes, and a second voltage not less in voltage level than the first high level voltage is applied to the plurality of first electrodes, and the plurality of third electrodes are biased with a positive third voltage for a second period that includes at least one part of a period for applying the second voltage to the plurality of first electrodes.

Another exemplary driving method according to an embodiment of the present invention drives a plasma display device having a plurality of first electrodes, a plurality of second electrodes, and a plurality of third electrodes formed in a direction crossing the plurality of first electrodes and the plurality of second electrodes. In addition, a plurality of discharge cells are formed in areas defined by the first, second, and third electrodes, and the driving method drives the plasma display device by dividing one frame into a plurality of subfields. The plurality of first electrodes are divided into a plurality of groups, and the respective subfields include a plurality of sustain periods and a plurality of address periods, which respectively correspond to the respective groups. In the driving method, in at least one subfield of the plurality of subfields, turn-on cells among discharge cells of each of the groups are selected during an address period of each of the groups. In a first sustain period that is between two neighboring address periods among the plurality of sustain periods, a first sustain discharge pulse alternatively having a first high level voltage and a first low level voltage is applied to the plurality of first electrodes, and the plurality of third electrodes are biased with a positive first voltage during a first period that includes at least one part of a period for initially applying the first high level voltage. In a second sustain period that is after the last address period of the at least one subfield among the plurality of sustain periods, the first high level voltage and the first low level voltage are alternately applied to the plurality of first electrodes and a voltage of the first electrodes is gradually increased after the low level voltage is finally applied to the plurality of first electrodes. Here, in one embodiment, a second voltage not less in voltage level than the first high level voltage is applied to the plurality of first electrodes, and the plurality of third electrodes are biased with a positive third voltage for a second period that includes at least one part of a period for applying the second voltage to the plurality of first electrodes.

In one embodiment, the first electrodes are scan electrodes, and the second electrodes are sustain electrodes.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 illustrates a schematic configuration of a plasma display device according to an exemplary embodiment of the present invention.

FIG. 2 is a driving waveform of a plasma display device according to a first exemplary embodiment of the present invention.

FIGS. 3A, 3B, 3C, 3D, and 3E respectively illustrate the state of wall charge distribution according to application of the driving waveform of the plasma display device according to the first exemplary embodiment of the present invention.

FIG. 4 is a diagram for representing a driving method of the plasma display device according to a second exemplary embodiment of the present invention.

FIG. 5 illustrates a driving waveform of the driving method according to the second exemplary embodiment of the present invention.

FIG. 6 is another driving waveform of the driving method according to the second exemplary embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Wall charges described in the following description refer to charges formed and accumulated on a wall (e.g. a dielectric layer) close to an electrode of a discharge cell. Here, the wall charge may be described as being “formed” or “accumulated” on the electrode, even though the wall charges may not actually touch the electrode. Further, a wall voltage refers to a potential difference formed on the wall of the discharge cell by the wall charges.

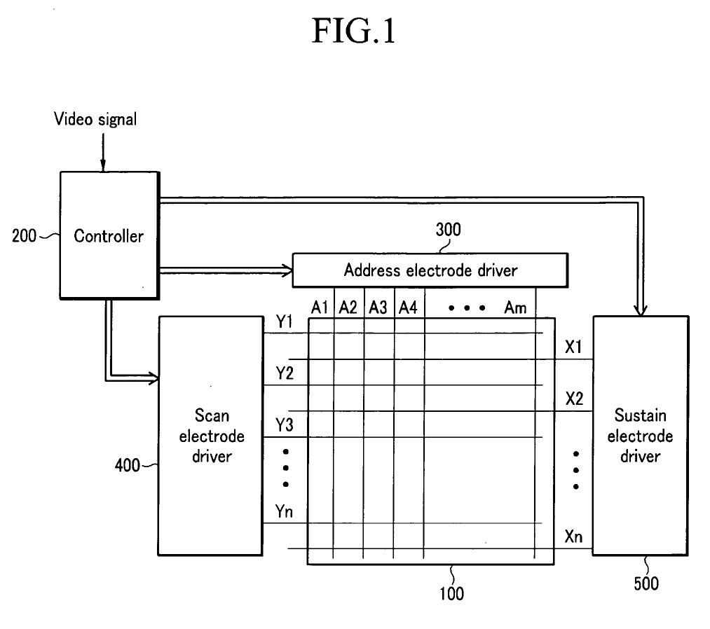

FIG. 1 is a schematic view of a plasma display device according to an exemplary embodiment of the present invention.

As shown in FIG. 1, the plasma display device includes a plasma display panel (PDP) 100, a controller 200, an address driver 300, a scan electrode driver 400, and a sustain electrode driver 500. The PDP 100 includes a plurality of address electrodes A1 to Am extending in a column direction, and a plurality of sustain electrodes X1 to Xn and a plurality of scan electrodes Y1 to Yn extending in a row direction. The plurality of scan electrodes Y1 to Yn and the plurality of sustain electrodes X1 to Xn are arranged as pairs. Discharge cells are formed in areas defined by where the address electrodes A1 to Am cross the sustain and scan electrodes X1 to Xn and Y1 to Yn.

The controller 200 externally receives a video signal and outputs an address driving control signal, a sustain electrode driving control signal, and a scan electrode driving control signal. In addition, the controller 200 divides a frame into a plurality of subfields and drives them. Each subfield includes a reset period, an address period, and a sustain period in a temporal manner. The address driver 300 receives the address driving control signal from the controller 200, and applies a display data signal for selecting turn-on discharge cells (i.e. discharge cells to be turned on) to the address electrodes A1 to Am. The scan electrode driver 400 receives the scan electrode driving control signal from the controller 200 and applies a driving voltage to the scan electrodes Y1 to Yn. The sustain electrode driver 500 receives the sustain electrode driving control signal from the controller 200 and applies a sustain electrode driving control signal to the sustain electrodes X1 to Xn.

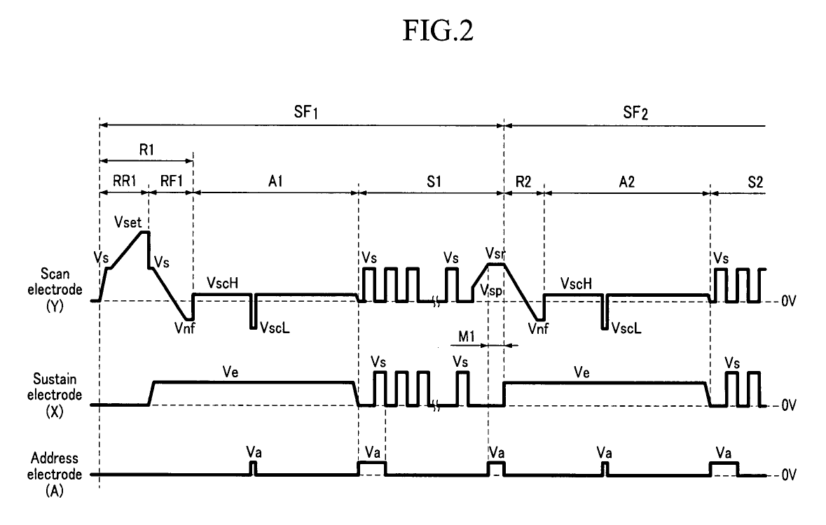

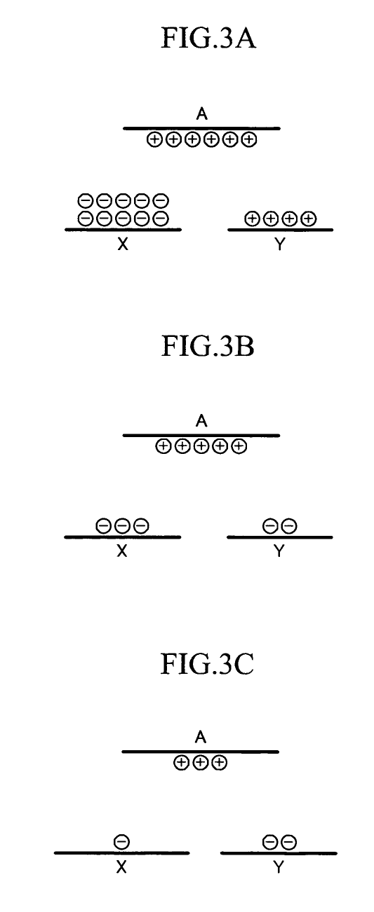

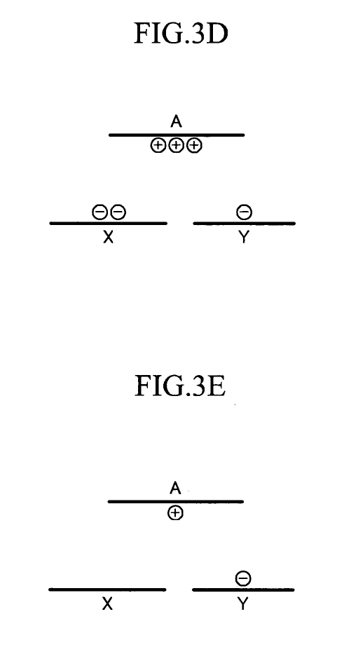

A driving method of a plasma display device according to a first exemplary embodiment of the present invention will be described with reference to FIG. 2, and FIG. 3A to FIG. 3E.

FIG. 2 shows a driving waveform of the plasma display device according to the first exemplary embodiment of the present invention, and FIG. 3A to FIG. 3E respectively show a wall charge distribution state in accordance with application of the driving waveform of the plasma display device of FIG. 2.

For ease of description, among a plurality of subfields, FIG. 2 exemplarily shows two subfields (hereinafter, referred to as a first subfield SF1 and a second subfield SF2, respectively). In addition, among a plurality of scan, sustain, and electrodes, FIG. 2 exemplarily shows the driving waveform applied to a scan electrode Y, a sustain electrode X, and an address electrode A.

As shown in FIG. 2, each of the first and second subfields SF1 and SF2 includes a reset period, an address period, and a sustain period. A reset period R1 of the first subfield SF1 includes a rising period RR1 and a falling period RF1, and a reset period R2 of the second subfield SF2 includes a falling period.

In the first subfield SF1, a voltage of the scan electrode Y is increased to a Vset voltage from a Vs voltage while a reference voltage (e.g., a ground voltage 0V, in FIG. 2) is applied to the sustain electrode X in the rising period RR1 of the reset period R1. Then, a weak discharge is generated between the scan electrode Y and the address electrode A and between the address electrode A and the sustain electrode X such that negative (−) wall charges are formed on the scan electrode Y and positive (+) wall charges are formed on the address electrode A and the sustain electrode X.

In the falling period RF1 of the reset period R1, the voltage of the scan electrode Y is gradually decreased to a Vnf voltage from the Vs voltage while a Ve voltage is applied to the sustain electrode X. Then, a weak discharge is generated between the scan electrode Y and the sustain electrode X and between the scan electrode Y and the address electrode A while the voltage of the scan electrode Y is decreased. Thus, the negative (−) wall voltages formed on the scan electrode Y and the positive (+) wall charges formed on the sustain electrode X and the address electrode A are erased.

Here, in one embodiment, all cells of the plasma display device are initialized to be turned off through the rising period RR1 and the falling period RF1 of the reset period R1.

Subsequently, in the address period A1, a scan pulse (or signal) having a VscL voltage is applied to the scan electrode Y for selecting a turn-on cell (or a cell to be turned on). Also, in the address period, a VscH voltage that has a higher voltage level than the VscL voltage is applied to other scan electrodes to which the VscL voltage is not applied (or the VscH is applied to the scan electrode Y when the VscL voltage is not applied). At this same time period, the sustain electrode X is applied with the Ve voltage. Here, the voltage level of the VscL voltage may be equal to or lower than that of the Vnf voltage.

In addition, an address pulse having a Va voltage is applied to the address electrode A to pass through the selected discharge cell among the plurality of discharge cells formed by the scan electrode Y to correspond to a period when the VscL voltage is applied, and another address electrode passing through an unselected discharge cell is biased with a reference voltage (e.g., 0V, in FIG. 2) (or the reference voltage is applied to the address electrode A when the Va voltage is not applied).

Then, the positive (+) wall charges are formed on the scan electrode Y and the negative (−) wall charges are formed on the sustain electrode X since an address discharge is generated on the discharge cell formed by the address electrode A to which the Va voltage is applied and the scan electrode Y to which the VscL voltage is applied. In addition, the negative (−) wall charges are formed on the address electrode A.

Subsequently, a sustain discharge pulse (or signal) repeatedly and alternately having the Vs voltage and the reference voltage is applied to the scan electrode Y and the sustain electrode X. Here, a sustain pulse phase applied to the scan electrode Y is opposite to a sustain pulse phase applied to the sustain electrode X.

That is, the sustain electrode X is biased with 0V when the Vs voltage is applied to the scan electrode Y, and the scan electrode Y is biased with 0V when the Vs voltage is applied to the sustain electrode X.

When a wall voltage is formed between the scan electrode Y and the sustain electrode X by the address discharge and the Vs voltage is applied to the scan electrode Y, a discharge is generated between the scan electrode Y and the sustain electrode X due to the wall voltage and the Vs voltage. As a result of this discharge, the negative (−) wall charges are formed on the scan electrode Y and the positive (+) wall charges are formed on the sustain electrode X. When the Vs voltage is applied to the sustain electrode X, the sustain discharge is generated once again and thus once again the positive (+) wall charges are formed on the scan electrode Y and the negative (−) wall charges are formed on the sustain electrode X. The process of repeatedly and alternately applying the sustain pulse of Vs to the scan electrode Y and the sustain electrode X is repeated for a number of times to correspond to a weight value of a corresponding subfield.

In FIG. 2, for a sustain period S1, a positive (+) Va voltage may be applied to the address electrode A while a first sustain discharge pulse at the Vs voltage is applied to the scan electrode Y in order to prevent a discharge from being generated between the address electrode A and the scan electrode Y. Here, the address electrode A may be still applied with the positive (+) Va voltage while the first sustain discharge pulse at the Vs voltage is applied to the sustain electrode X.

In more detail, referring also to FIG. 3A, a state of the cell having been sustain-discharged is shown. Subsequently, the voltage of the scan electrode Y is increased to a Vsr voltage from a Vsp voltage while the sustain electrode X is biased with the reference voltage (e.g., 0V in FIG. 2) during a period for generating the last sustain discharge. Then, a weak discharge is generated between the scan electrode Y and the sustain electrode X and thus wall charges formed on the scan electrode Y and the sustain electrode X are eliminated as shown in FIG. 3B.

In addition, after the voltage of the scan electrode Y is gradually increased to the Vsr voltage, the Vsr voltage is applied to the scan electrode Y for a period M1 and a positive voltage is applied to the address electrode A while the Vsr voltage is applied to the scan electrode Y. At this time, the Vs voltage may be applied to the scan electrode Y during the period M1.

Among space charges formed by the previous weak discharge, negative (−) charges are formed on the address electrode A and positive (+) charges are formed on the sustain electrode X caused by a voltage difference between the address electrode A and the sustain electrode X during the period M1. That is, as shown in the wall charge state of FIG. 3C, more positive (+) wall charges formed on the address electrode A and more negative (−) wall charges formed on the sustain electrode X are eliminated than in the wall charge state of FIG. 3B.

In addition, an additional power source for supplying the positive voltage may not be required when the Va voltage is used as the positive voltage applied to the address electrode A.

Similar to the falling period RF1 of the first subfield SF1, the voltage of the scan electrode Y is decreased to the Vnf voltage from the Vsr voltage (or Vs voltage) while the sustain electrode X is biased with the Ve voltage for the reset period R2 of the second subfield SF2. Here, in the reset period R2 of the second subfield SF2, a discharge is not generated in the cells that are not selected to be turned on in the first subfield SF1 since the voltage applied during the reset period R2 of the second subfield SF2 equals the voltage applied during the falling period RF1 of the first subfield SF1. Also, the cells that have been selected to be turned on and thus have been sustain-discharged in the first subfield SF are discharged such that the negative (−) wall charges formed on the scan electrode Y and the positive (+) wall charges formed on the address electrode A are eliminated. That is, only the cells having been sustain-discharged in the first subfield SF1, which is the previous subfield of the reset period R2 of the second subfield SF2, are initialized.

Here, when the address electrode A is not applied with the positive voltage at the end of the sustain period S1 of the first subfield SF1, the cells are initialized and thus the wall charge state of FIG. 3B is changed to that of FIG. 3D. That is, the cells are initialized at the state of having a considerable amount of (+) wall charges formed on the address electrode A.

By contrast, when the positive voltage is applied to the address electrode A at the end of the sustain period S1 of the first subfield SF1, the cells are initialized and thus the wall charge state of FIG. 3C is changed to that of FIG. 3E. That is, here in FIG. 3C, wall charge elimination is performed in the state of having a relatively small amount of positive (+) wall charges formed on the address electrode A as compared with state of FIG. 3B. Therefore, in FIG. 3E, a relatively small amount of (+) wall charges remains on the address electrode A as compared to the state of FIG. 3D.

Subsequently, in an address period A2 of the second subfield SF2, similar to the address period A1 of the first subfield SF1, the scan pulse (or signal) having a VscL voltage is applied to the scan electrode Y and thus one or more turn-on cells are selected. Unselected cells maintain the wall charge state that has been formed during the reset period.

For a sustain period S2, a sustain discharge pulse (or signal) repeatedly and alternately having the Vs voltage and the reference voltage is applied to the scan electrode Y and the sustain electrode X. Here, a sustain discharge pulse phase applied to the scan electrode Y is opposite to a sustain discharge pulse phase applied to the sustain electrode X. In addition, a positive Va voltage is applied to the address electrode A during the application of the first sustain discharge pulse. In the unselected cells in the state of FIG. 3D, a misfiring effect (or an inappropriate discharge) may be generated between the address electrode A and the sustain electrode X due to the (+) wall charges formed on the address electrode A and the positive voltage applied to the address electrode A.

However, according to the first exemplary embodiment of the present invention, since an insufficient amount of the (+) wall charges is formed on the address electrode A in the unselected cells at the end of the sustain period as shown in FIG. 3E, a misfiring effect is not generated (or substantially reduced) between the address electrode A and the sustain electrode X at the early stage of a sustain period.

In FIG. 2, it is described that the address electrode A is applied with a pulse width of the positive voltage (i.e., Va voltage) that corresponds to that of the Vsr voltage (i.e., the positive voltage is applied for the same period M1 as the Vsr voltage is applied). However, in another embodiment of the invention, a pulse width of the Va voltage may be set less than that of the Vsr voltage.

In addition, in FIG. 2, it is described that the positive voltage is applied to the address electrode A when the first pulse and last pulses having the Vs voltages are applied to the scan electrode Y. However, in another embodiment of the invention, the address electrode A may be floated when the first pulse having the Vs voltage is applied to the scan electrode Y in the sustain period. Then, a voltage of the address electrode A increases to the positive voltage, along with the Vs voltage of the scan electrode Y.

Here, the scan pulse (or signal) is sequentially applied to the plurality of scan electrodes Y1 to Yn for the address period according to the first exemplary embodiment of the present invention and thus an addressing operation is sequentially performed. After the addressing operation is applied to all the cells in the address period, a sustain discharging operation is applied to the turn-on cell in the sustain period.

Accordingly, a sustain discharge occurs in a previously addressed discharge cell after a relatively long idle time as compared to in another discharge cell. In a discharge cell having a long idle time, priming particles and/or a wall voltage formed in the discharge cell by the addressing operation may be reduced. Hence, the sustain discharging operation may become unstable.

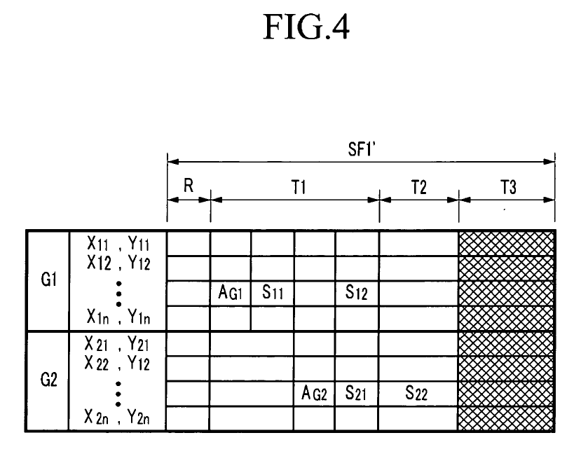

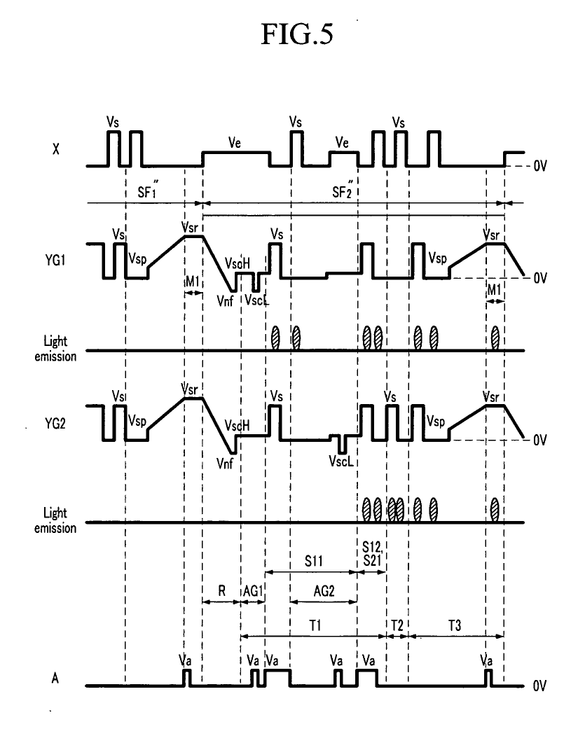

An exemplary embodiment for reducing or preventing an occurrence of an unstable sustain discharge will now be described with reference to FIGS. 4, 5, and 6.

FIG. 4 shows a driving method of a plasma display device according to a second exemplary embodiment of the present invention.

As shown in FIG. 4, a plurality of scan electrodes Y1 to Yn are divided into at least two groups, referred to as a first group G1 and a second group G2.

Here, the first group G1 may include odd-numbered scan electrodes and the second group G2 may include even-numbered scan electrodes, or the first group G1 may include scan electrodes formed in an upper portion the PDP 100 and the second group G2 may include scan electrodes formed in a lower portion of the PDP 100. In addition, the plurality of scan electrodes Y1 to Yn may be divided into three or more groups.

As shown in FIG. 4, a subfield SF1′ includes a reset period R, an address/sustain combination period T1, a brightness correction period T2, and a common sustain period T3.

In the reset period R, a reset waveform is applied to all the discharge cells of the first and second groups G1 and G2 to reset the wall charge state of the discharge cells.

In the address/sustain combination period T1, an addressing operation is applied to discharge cells in the first group G1 during an addressing period A_{G1} to select turn-on cells, and subsequently a sustain operation is applied to provide sustain discharge in the selected cells in the first group G1 during the sustain period S₁₁.

Next, an addressing operation is applied to discharge cells in the second group G2 during the addressing period A_{G2} to select turn-on cells, and subsequently a sustain operation is applied to provide sustain discharge in the selected cells of the first and second groups G1 and G2 during the sustain periods S₁₂ and S₂₁, respectively.

When the address/sustain combination period T1 is performed as described above, two sustain periods S₁₁, and S₁₂ are applied to the selected cells in the first group G1 as compared to one sustain period S₂₁ applied to the selected cells in the second group G2.

The number of sustain periods (or operations) applied to the selected cells in each group may vary, which leads to a corresponding variance in brightness of cells in the first and second group G1 and G2.

To compensate for this brightness variance, a brightness correction operation T2 is applied so as to correct the brightness difference of the respective groups according to the second exemplary embodiment of the present invention. In the brightness correction period T2, the sustain discharge operation is selectively applied so that the same number of sustain discharges is generated at each of the selected cells in the first and second groups G1 and G2.

That is, in one embodiment as shown in FIG. 4, a sustain period (or operation) S₂₂ is applied to the turn-on cells of the second group G2 while the turn-on cells in the first group G1 are not being sustain-discharged such that brightness of the turn-on cells of the second group G2 correspond to that of the turn-on cells of the first group G1. That is, the turn-on cells of the second group G2 are sustain-discharged in the brightness correction period T2.

Accordingly, the same number of sustain discharges can be generated at each selected cell in groups G1 and G2.

In addition, in the common sustain period T3, a sustain operation is applied in common to provide sustain discharge in the turn-on cells of the first and second groups G1 and G2 for a period (or predetermined period) of time. As such, a brightness weight value of the corresponding subfield may be set by controlling the length of the common sustain period T3.

It is illustrated further in FIG. 4 that the common sustain period T3 is applied after the brightness correction period T2, but it is also possible to apply the common sustain period T3 before the brightness correction period T2. Also, in one embodiment, when the brightness weight value of the corresponding subfield expresses a desired grayscale level by the address/sustain combination in the period T1 and the brightness correction period T2, the common sustain period T3 does not have to be performed.

In addition, the brightness correction period T2 may be included in the address/sustain combination period T1. In FIG. 4, for example, when a turn-on cell of the first group G1 expresses a desired grayscale level by the operation of the sustain period S₁₁, the turn-on cell of the first group G1 may be set to generate no sustain discharge during the operation of the subsequent sustain period S₁₂.

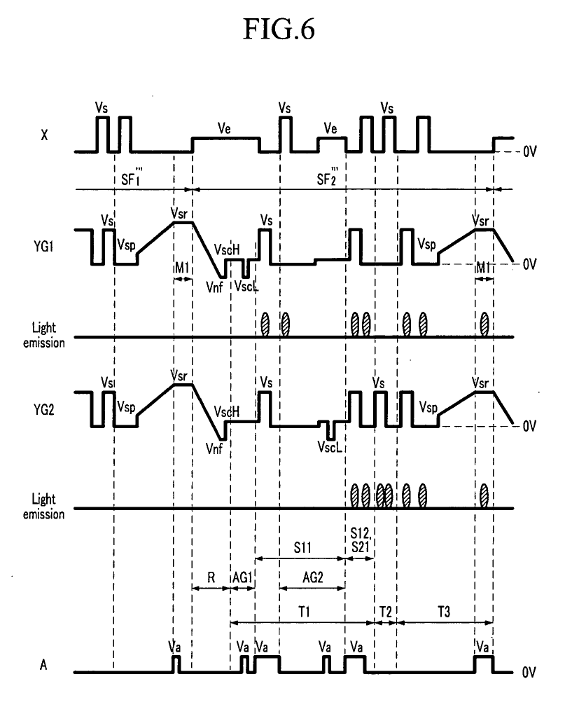

Driving waveforms for realizing the plasma display driving method of FIG. 4 will be described in more detail with reference to FIG. 5 and FIG. 6.

FIG. 5 is a driving waveform of the driving method according to the second exemplary embodiment of the present invention. For ease of description, a scan electrode YG1 of the first group G1, a scan electrode YG2 of the second group G2, a sustain electrode X, and an address electrode A are illustrated in FIG. 5. In addition, among the plurality of subfields, FIG. 5 illustrates a part of the first subfield SF1″ and the second subfield SF2″.

As shown in FIG. 5, the driving waveform here is similar to that the waveform of FIG. 2, but, unlike the waveform of FIG. 2, an address period A_{G1} of the first group G1 and an address period A_{G2} of the second group G2 are separated.

Specifically, in a reset period R of the second subfield SF2″, a reset waveform is applied to the scan electrodes YG1 and YG2 of the first and second groups to reset the wall charge state of discharge cells. That is, voltages of the scan electrodes YG1 and YG2 are gradually decreased while the sustain electrode X is applied with a Ve voltage.

Subsequently, an addressing operation is applied to the first group G1 during a address/sustain combination period T1. Here, in the address period A_{G1}, a scan pulse of VscL voltage is applied to the scan electrode YG1 of the first group while the Ve voltage is applied to the sustain electrode X. At this same time period, a VscH voltage that is higher in voltage level than the VscL voltage is applied to the scan electrode YG2 of the second group and other scan electrodes of the first group to which no scan pulse of VscL voltage is applied (or the VscH voltage is applied to the scan electrode YG1 of the first group when the scan pulse of VscL voltage is not applied).

At this time period, a discharge is not generated in the scan electrode YG2 of the second group since the VscL voltage is not applied thereto, and accordingly, turn-on cells are selected from among discharge cells formed by the scan electrode YG1 (applied with the VscL voltage) and the sustain electrode X of the first group.

In the sustain period S₁₁ of the address/sustain combination period T1, a sustain pulse is applied to the scan electrodes YG1 and YG2 and the sustain electrode X. A sustain pulse phase applied to the scan electrodes YG1 and YG2 is opposite to a sustain pulse phase applied to the sustain electrode X (i.e., one is at a high voltage level when the other is at a low voltage level). Here, in FIG. 5, a single sustain discharge pulse is applied once to the scan electrodes YG1 and YG2 and a single sustain discharge pulse is applied once to the sustain electrode X.

When the Vs voltage is applied to the scan electrodes YG1 and YG2, and a reference or ground voltage (e.g., 0V, in FIG. 5) is applied to the sustain electrode X in the sustain period S₁₁, the turn-on cells of the first group YG1 which have been selected in the address period AG1 are sustain-discharged. Subsequently, the reference or ground voltage (e.g., 0V) is applied to the scan electrodes YG1 and YG2, and the Vs voltage is applied to the sustain electrode X such that the corresponding turn-on cells are sustain-discharged once again.

Also, although the sustain discharge pulse is applied to the scan electrode YG2 of the second group, no sustain discharge is generated because a wall voltage is not formed between the scan electrode YG2 and the sustain electrode X.

At this time period, a positive Va voltage is applied to the address electrode A in order to prevent misfiring between the address electrode A and the scan electrode YG1 in the sustain period S₁₁ of the second subfield SF2″.

Subsequently, the addressing operation is applied to the second group YG2 in the address period A_{G2}. In the address period A_{G2}, the scan pulse of VscL voltage is sequentially applied to the scan electrode YG2 while the Ve voltage is applied to the sustain electrode X.

At this time period, the VscH voltage is applied to the scan electrode YG1 of the first group to which the scan pulse of VscL voltage is not applied and another scan electrode of the second group to which the scan pulse of the VscL voltage is not applied (or the VscH voltage is applied to the scan electrode YG2 of the second group when the scan pulse of VscL voltage is not applied).

Then, a discharge is generated in a discharge cell formed by the scan electrode YG2 of the second group to which the scan pulse of the VscL voltage is applied and the address electrode A applied with the address voltage Va so that the discharge cell associated with the scan electrode YG2 is selected to be a turn-on cell.

Subsequently, in the sustain periods S₁₂ and S₂₁ of the address/sustain combination period T2, a single sustain discharge pulse is applied to the scan electrodes YG1 and YG2 and a single sustain pulse is then applied to the sustain electrode X. Here, a sustain pulse phase applied to the scan electrodes YG1 and YG2 is opposite to a sustain pulse phase applied to the sustain electrode X. That is, initially, a reference or ground voltage (e.g., 0V) is applied to the sustain electrode X, and the Vs voltage is applied to the scan electrodes YG1 and YG2 so that the turn-on cells of the first and second groups are sustain-discharged.

Next, the Vs voltage is applied to the sustain electrode X, and the reference or ground voltage (e.g., 0V) is applied to the scan electrodes YG1 and YG2 so the turn-on cells of the first and second groups are sustain-discharged again.

In addition, positive (+) wall charges are formed on the scan electrodes YG1 and YG2 of the turn-on cells of the first and second groups and negative (−) wall charges are formed on the sustain electrode X.

At this time period, as previously described, the positive voltage is applied to the address electrode A in order to reduce or prevent an occurrence of misfiring between the address electrode A and the scan electrode(s) YG2 and/or YG1.

Since the sustain discharges are generated twice more in the turn-on cells of the first group G1 during the sustain period S₁₁ as compared to the sustain discharges in the turn-on cells of the second group G2, the brightness correction period T2 is applied to generate two more sustain discharges in the turn-on cells of the second group G2 as compared to the sustain discharges in the turn-on cells of the first group G1.

That is, a reference or ground voltage (e.g., 0V) is concurrently applied to the scan electrode YG1 of the first group and the sustain electrode X in the brightness correction period T2. In addition, the Vs voltage is applied to the scan electrode YG2 of the second group G2. Accordingly, a sustain discharge is generated in the turn-on cells of the second group by a voltage difference Vs between the scan electrode YG2 and the sustain electrode X. However, no sustain discharge is generated at the turn-on cells of the first groups since the voltage difference between the scan electrode YG1 and the sustain electrode X is at the reference or ground voltage (e.g., 0V).

Subsequently, the reference or ground voltage (e.g., 0V) is applied to the scan electrodes YG1 and YG2 of the first and the second group while the Vs voltage is applied to the sustain electrode X. At this time period, the positive (+) wall charges are formed on the scan electrode YG1 since the turn-on cells of the first group are not sustain-discharged, and therefore, a sustain discharge is not generated even though 0V is applied to the scan electrode YG1. However, another sustain discharge is generated in the turn-on cells of the second group by a voltage difference Vs between the scan electrode YG2 and the sustain electrode X.

As described, in the brightness correction period T2 according to one embodiment, since the turn-on cells of the second group are sustain-discharged two more times in the turn-on cell of the second group while the turn-on cells of the first group are in the state of not being sustain-discharged, brightness variance between the turn-on cells of the first group and the second group are compensated.

Next, in the common sustain period T3, the sustain discharge pulse is applied to the scan electrodes YG1 and YG2 of the first and the second groups and the sustain electrode X so that the turn-on cells of both groups are sustain-discharged in common.

Subsequently, in a period for generating the last sustain discharge, the voltage of the scan electrode Y is gradually increased from the Vsp voltage to the Vsr voltage while the reference or ground voltage (e.g., 0V, in FIG. 5) is applied to the sustain electrode X. Then, the Vsr voltage is applied to the scan electrodes YG1 and YG2 for a period M1, and a positive voltage is applied to the address electrode A while the Vsr voltage is applied to the scan electrodes YG1 and YG2. At this time period, the Vs voltage may be applied to the scan electrodes YG1 and YG2 during the period M1.

Therefore, the occurrence of misfiring in turn-off cells (i.e., cells to be turned off) can be prevented by the positive voltage applied to the address electrode in the sustain period S₁₁ and S₂₁.

FIG. 6 is another driving waveform of the driving method according to the second exemplary embodiment of the present invention.

As shown in FIG. 6, the driving waveform of FIG. 6 is substantially the same as the drive waveform of FIG. 5, except that a sustain discharge pulse of a Vsr voltage is lastly applied to scan electrodes YG1 and YG2 during a sustain period T3 of first and second subfields SF1′″ and SF2′″, and, at the same time period T3, a positive voltage Va having a pulse width that is the same as a pulse width of the sustain discharge pulse of the Vsr is applied to an address electrode A.

As described above, according to an exemplary embodiment of the present invention, an occurrence of misfiring (or inappropriate discharge) between an address electrode and a sustain electrode of a discharge cell that has not been address discharged during a sustain period is reduced or prevented by applying a voltage to the address electrode during at least a part of a period of applying a last sustain discharge pulse that has been gradually increased.

In addition, according to another exemplary embodiment of the present invention, the time between the addressing operation and the sustain discharge operation can be reduced to thereby generate smooth sustain discharges.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A driving method for a plasma display device having a plurality of first electrodes, a plurality of second electrodes, a plurality of third electrodes formed in a direction crossing the plurality of first electrodes and the plurality of second electrodes, and a plurality of discharge cells formed in areas defined by the first electrodes, the second electrodes, and the third electrodes, the driving method comprising:
in a sustain period of at least one subfield of a plurality of subfields,
applying a first sustain discharge pulse alternately having a first high level voltage and a first low level voltage to the plurality of first electrodes;
biasing the plurality of third electrodes with a positive first voltage for a first period including at least one part of a period for initially applying the first high level voltage to the plurality of first electrodes;
gradually increasing a voltage of the plurality of first electrodes after finally applying the first high level voltage to the plurality of first electrodes;
applying a second voltage not less in voltage level than the first high level voltage to the plurality of first electrodes; and
biasing the plurality of third electrodes with a positive third voltage for a second period including at least one part of a period for applying the second voltage to the plurality of first electrodes.

2. The driving method of claim 1, further comprising:
in the sustain period,
applying a second sustain discharge pulse alternately having a second high level voltage and a second low level voltage to the plurality of second electrodes in an opposite phase to the first sustain discharge pulse, and
wherein the first period further comprises at least one part of a period for initially applying the second high level voltage to the plurality of second electrodes.

3. The driving method of claim 1, wherein the first voltage has substantially the same voltage level as the third voltage.

4. The driving method of claim 1, wherein the second voltage has substantially the same voltage level as the first high level voltage.

5. The driving method of claim 1, further comprising, in an address period of the at least one subfield, respectively applying a fourth voltage and a fifth voltage to the first and third electrodes of at least one discharge cell of the plurality of discharge cells to be turned on in the sustain period, and wherein at least one of the first voltage or the third voltage has substantially the same voltage level as the fifth voltage.

6. The driving method of claim 1, wherein the plurality of third electrodes are floated during the first period.

7. The driving method of claim 1, further comprising gradually decreasing a voltage of the first electrodes during a reset period of another subfield of the plurality of subfields, wherein the another subfield is followed by the at least one subfield.

8. A driving method of a plasma display device having a plurality of first electrodes, a plurality of second electrodes, a plurality of third electrodes formed in a direction crossing the first and second electrodes, and a plurality of discharge cells formed in areas defined by the crossing of the first electrodes and the second electrodes with the third electrodes, the driving method driving the plasma display device by dividing one frame into a plurality of subfields, the driving method comprising:
dividing the plurality of first electrodes into a plurality of groups, wherein the subfields comprise a plurality of sustain periods and a plurality of address periods to correspond to the groups;
in at least one subfield of the plurality of subfields,
selecting turn-on cells among the discharge cells of each of the groups during an address period of each of the groups;
in a first sustain period between two neighboring address periods among the plurality of sustain periods, applying a first sustain discharge pulse alternately having a first high level voltage and a first low level voltage to the plurality of first electrodes, and biasing the plurality of third electrodes with a positive first voltage during a first period including at least one part of a period for initially applying the first high level voltage;
in a second sustain period located after a last address period of the at least one subfield among the plurality of sustain periods, alternately applying the first high level voltage and the first low level voltage to the plurality of first electrodes, and gradually increasing a voltage of the plurality of first electrodes after the low level voltage is finally applied to the plurality of first electrodes;
applying a second voltage not less in voltage level than the first low level voltage to the plurality of first electrodes; and
biasing the plurality of third electrodes with a positive third voltage during a second period including at least one part of a period for applying the second voltage to the first electrodes.

9. The driving method of claim 8, further comprising:
in the first and second sustain periods,
applying a second high level voltage and a second low level voltage to the plurality of second electrodes in the opposite phase to the first high level voltage and the first low level voltage applied to the plurality of first electrodes, and
wherein the first period further comprises at least one part of a period for initially applying the second high level voltage to the plurality of second electrodes.

10. The driving method of claim 8, wherein the first voltage has substantially the same voltage level as the third voltage.

11. The driving method of claim 8, wherein the second voltage has substantially the same voltage level as the first high level voltage.

12. The driving method of claim 8, further comprising in an address period of the at least one subfield, applying a fourth voltage and a fifth voltage to the plurality of first electrodes and the plurality of third electrodes of at least one discharge cell of the plurality of discharge cells to be turned on during a sustain period, and wherein at least one of the first voltage or the third voltage has substantially the same voltage level as the fifth voltage.

13. The driving method of claim 8, wherein the plurality of third electrodes are floated during the first period.

14. The driving method of claim 8, further comprising gradually decreasing a voltage of the plurality of first electrodes during a reset period of another subfield of the plurality of subfields, wherein the another subfield is followed by the at least one subfield.

15. A driving method for a plasma display device having a first electrode, a second electrode, an address electrode formed in a direction crossing the first electrode and the second electrode, and a discharge cell formed in an area defined by the first electrode, the second electrode, and the address electrode, the driving method comprising:
in a sustain period of at least one subfield of a plurality of subfields,
applying a first sustain discharge pulse alternately having a first high level voltage and a first low level voltage to the first electrode;
biasing the address electrode with a positive first voltage for a first period including at least one part of a period for initially applying the first high level voltage to the first electrode;
gradually increasing a voltage of the first electrode after finally applying the first high level voltage to the first electrode;
applying a second voltage not less in voltage level than the first high level voltage to the first electrode; and
biasing the address electrode with a positive third voltage for a second period including at least one part of a period for applying the second voltage to the first electrode.

16. The driving method of claim 15, further comprising:
in the sustain period,
applying a second sustain discharge pulse alternately having a second high level voltage and a second low level voltage to the second electrode in an opposite phase to the first sustain discharge pulse, and
wherein the first period further comprises at least one part of a period for initially applying the second high level voltage to the second electrode.

17. The driving method of claim 15, wherein the first voltage has substantially the same voltage level as the third voltage.

18. The driving method of claim 15, wherein the second voltage has substantially the same voltage level as the first high level voltage.

19. The driving method of claim 15, wherein the second voltage is higher in voltage level than that of the first high level voltage.

20. The driving method of claim 15, wherein a plurality of first electrodes are divided into a plurality of groups, the method further comprising:
selecting turn-on cells among the discharge cells of each of the groups during an address period of each of the groups, wherein the sustain period comprises a first sustain period and a second sustain period;
in the first sustain period between two neighboring address periods, applying the first sustain discharge pulse alternately having the first high level voltage and the first low level voltage to the first electrode, and biasing the address electrode with the positive first voltage during the first period including the at least one part of the period for initially applying the first high level voltage, and
wherein, in the second sustain period located after a last address period of the at least one subfield, alternately applying the first high level voltage and the first low level voltage to the first electrode, and gradually increasing a voltage of the first electrode after the low level voltage is finally applied to the first electrode.
